(19) United States
(12) Patent Application Publication
(10) Pub. No.: US 2019/0082378 A1
(43) Pub. Date: Mar. 14, 2019

(54) LOCATION-BASED VEHICLE AND MOBILE DEVICE INTEGRATION SYSTEM

(71) Applicant: GM GLOBAL TECHNOLOGY OPERATIONS LLC, Detroit, MI (US)

(72) Inventor: Robert A. Dziurda, Waterford, MI (US)

(21) Appl. No.: 15/704,927

(22) Filed: Sep. 14, 2017

(51) Int. Cl. H04W 48/04; H04W 4/00; H04W 4/04; H04L 29/08; H04W 64/00; H04W 84/18

(52) U.S. Cl. CPC H04W 48/04; H04W 4/008; H04W 84/18; H04L 67/12; H04W 64/003; H04W 4/046

(57) ABSTRACT

A vehicle communications system and associated method that provide location-based pairing schemes for vehicles and mobile devices. One or more pairing sites may be located at discrete locations within the interior of the vehicle and may facilitate pairing of a mobile device that is in a prescribed range of the pairing site. A proximity sensor associated with the pairing site may be used to determine the position of the mobile device relative to the prescribed range. Each pairing site may have customizable rules and preferences that control how and what information is pushed from the mobile device to one or more vehicle user interfaces.

### INTRODUCTION

The disclosure relates to pairing mobile devices in vehicles, and more particularly, to location-based pairing of mobile devices within a vehicle interior.

Most vehicles provide a menu-based or vocal-based pairing system to allow users to pair one or more mobile devices with the vehicle. Typically, the pairing system is an all-or-nothing type of system. In other words, once a mobile device is paired, it may be difficult to change to another mobile device present in the vehicle, or it may be difficult to selectively choose what media, calls, etc. are interfaced through various vehicle subsystems.

### SUMMARY

According to a first embodiment, there is provided a communications system for a vehicle. The communications system includes a primary mobile device pairing locus. The primary mobile device pairing locus is configured to be accessible to a mobile device in the vehicle from any location within an interior of the vehicle. The communications system also includes a pairing site. The pairing site is located at a discrete location within the interior of the vehicle and is configured to be one of the following types of pairing sites: a total functionality pairing site, an all-media pairing site, a partial media pairing site, or a vehicle-based functionality pairing site. The pairing site is configured to override at least some functionality of a mobile device paired via the primary mobile device pairing locus when a mobile device is paired via the pairing site.

According to other embodiments, there is provided that of the first embodiment further including any one or more of the following:
a second pairing site, wherein the second pairing site is located at a second discrete location within the interior of the vehicle and is configured to be one of the following types of pairing sites: a total functionality pairing site, an all-media pairing site, a partial media pairing site, or a vehicle-based functionality pairing site;
wherein the first pairing site and the second pairing site are different types of pairing sites;
wherein the discrete location of the pairing site includes a phone docking station, a console bin, or a cup holder;
wherein the pairing site includes a proximity sensor configured to determine a position of a mobile device in the vehicle;
wherein the proximity sensor is configured such that when the mobile device is inside of a prescribed range as determined at least partly by the proximity sensor, information will be pushed from the mobile device to a vehicle user interface;
wherein the proximity sensor is configured such that when the mobile device is outside of a prescribed range as determined at least partly by the proximity sensor, information will not be pushed from the mobile device to a vehicle user interface;
wherein the discrete location includes a mobile device charger;
wherein the type of pairing site is an all-media pairing site or a partial media pairing site, and the discrete location is in a back seat area of the vehicle; or
wherein the pairing site is an all-media pairing site or a partial media pairing site associated with a display screen.

According to a second embodiment, there is provided a vehicle communications system for a vehicle. The communications system includes an infotainment system including a vehicle user interface, and a pairing site that is located at a discrete location within the interior of the vehicle and is configured to be one of the following types of pairing sites: a total functionality pairing site, an all-media pairing site, a partial media pairing site, or a vehicle-based functionality pairing site. The pairing site includes a proximity sensor configured to determine a position of a mobile device in the vehicle, and when the mobile device is moved from inside of a prescribed range as determined at least partly by the proximity sensor to outside of the prescribed range as determined at least partly by the proximity sensor, information will stop being pushed from the mobile device to the vehicle user interface of the infotainment system.

According to other embodiments, there is provided that of the second embodiment further including any one or more of the following:
wherein the proximity sensor is a wireless access point that is configured to determine a position of a mobile device using a received signal strength indication (RSSI);
wherein a communication protocol of the pairing site is near field communication (NFC), Bluetooth, or Bluetooth Low Energy (BLE); or
wherein the information being pushed from the mobile device is a cellular call that is placed into a private mode when the mobile device is moved from inside of the prescribed range to outside of the prescribed range.

According to a third embodiment, there is provided a vehicle communications system. The vehicle communications system includes a first pairing site, the first pairing site being one of the following types of pairing sites: a total functionality pairing site, an all-media pairing site, a partial media pairing site, or a vehicle-based functionality pairing site. The vehicle communications system also includes a second pairing site, the second pairing site being one of the following types of pairing sites: a total functionality pairing site, an all-media pairing site, a partial media pairing site, or a vehicle-based functionality pairing site. The first pairing site and the second pairing site are different types of pairing sites, and the first pairing site and the second pairing site are located in different discrete locations within an interior of the vehicle.

According to other embodiments, there is provided that of the third embodiment further including any one or more of the following:
wherein pairing is automatic at the first pairing site and pairing at the second pairing site requires a password; or
wherein the first pairing site is a total functionality pairing site located at a phone docking station or a console bin and the second pairing site is an all-media pairing site or a partial media pairing site that is located in a back seat area of the vehicle.

### BRIEF DESCRIPTION OF THE DRAWINGS

Exemplary embodiments will hereinafter be described in conjunction with the appended drawings, wherein like designations denote like elements, and wherein:

FIG. 1 is a block diagram depicting an embodiment of a global communications system including a vehicle communications system;

FIG. 2 illustrates an embodiment of the vehicle communications system of FIG. 1; and

FIG. 3 is a flowchart illustrating a method of managing the vehicle communications system of FIGS. 1 and 2.

### DETAILED DESCRIPTION

The vehicle communications systems and associated methods described herein enable location-based vehicle and mobile device integration. Through the use of various pairing sites situated at discrete locations within the interior of a vehicle, different integration levels and functionalities may be obtained. One or more pairing sites may be associated with customizable rules that allow for information from the mobile device to be pushed to the vehicle in a selective fashion depending on the rules of a particular pairing site. The vehicle communications systems and methods may be particularly useful in ride sharing vehicles, whether such vehicles are autonomous, semi-autonomous, or not autonomous. In ride sharing vehicles or any other vehicle equipped with the present systems, situations such as determining whose phone will play music, sharing videos or other media, or accepting private calls, to cite a few examples, may be more easily reconciled than with more traditional, menu-based or vocal-based pairing systems. In some systems, it may be distracting to change media inputs between multiple mobile devices or to switch calls between private mode (i.e., the mobile device) and a paired mode with the vehicle. Some embodiments of the present disclosure may help abate such distractions and can result in an improved human machine interface (HMI) and reduced driver workload. Further, at least some embodiments may provide a clear and intuitive way to manage multiple mobile devices connected within a single vehicle.

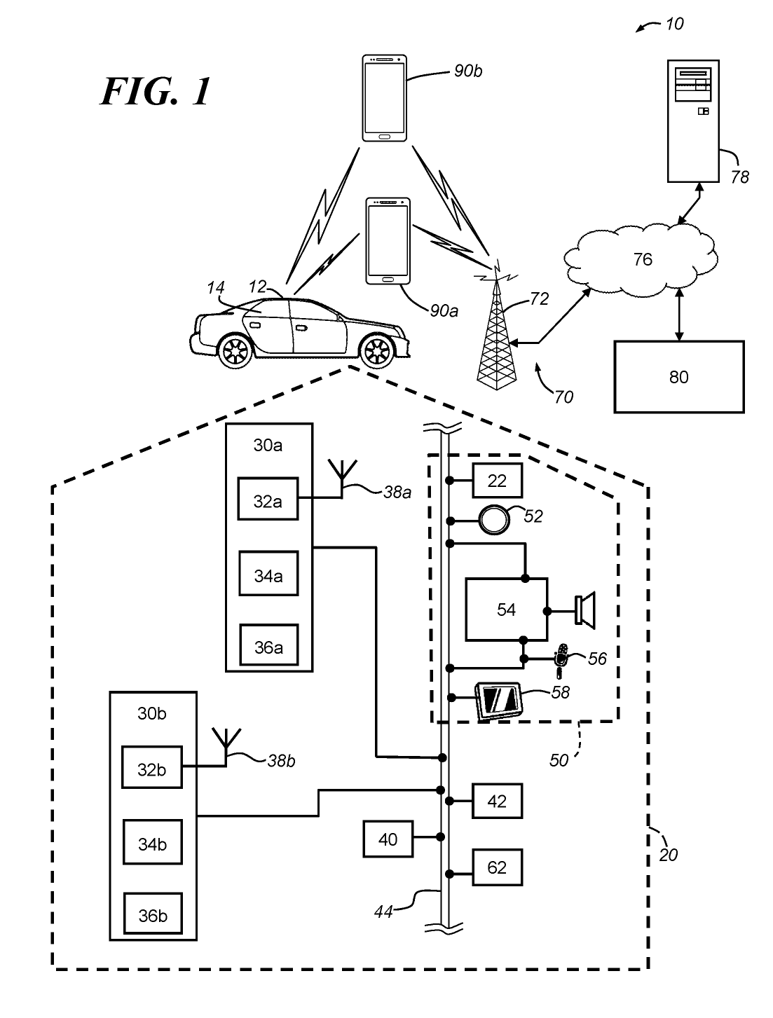

Referring now to FIG. 1, there is shown an operating environment that comprises a global communications system 10. Global communications system 10 generally includes a vehicle 12 with a vehicle communications system 20, one or more wireless carrier systems 70, and one or more mobile devices 90a, 90b. The vehicle communication system 20 may include one or more pairing sites 30a, 30b, a primary mobile device pairing locus 40, one or more vehicle system modules 42, and an infotainment system 50. It should be understood that the disclosed systems and methods can be alternatively configured and are not specifically limited to the operating environment shown here. Thus, the following paragraphs simply provide a brief overview of one example of a global communications system 10; however, other global communications systems are certainly possible.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which include telematics equipment in vehicle 12). Carrier system 70 can implement any suitable communications technology, including for example GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. Each such computer 78 can be used for one or more purposes, such as a web server accessible by vehicle 12. Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a ride or car sharing service; or a third party repository to or from which vehicle data or other information is provided, whether by communicating with the vehicle 12, remote facility 80, or both. A computer 78 can also be used for providing Internet connectivity such as DNS services or as a network address server that uses DHCP or other suitable protocol to assign an IP address to the vehicle 12.

Remote facility 80 may be designed to provide the vehicle 12 and mobile device 90 with a number of different system back-end functions. The remote facility 80 may include one or more switches, servers, databases, live advisors, as well as an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76.

Mobile devices 90a, 90b may be short-range wireless communication (SRWC) devices and may include: hardware, software, and/or firmware enabling cellular telecommunications and SRWC as well as other mobile device applications. The mobile device 90 is typically portable by a user, such as a wearable device (e.g., a smartwatch), an implantable device, or a handheld device (e.g., a smartphone, a tablet, a laptop). The hardware of the personal mobile device 90 may comprise: a processor and memory (e.g., non-transitory computer readable medium configured to operate with the processor) for storing the software, firmware, etc. The mobile device's processor and memory may enable various software applications, which may be preinstalled or installed by the user (or manufacturer) (e.g., having a software application or graphical user interface or GUI). One implementation of a vehicle-mobile device application may enable a vehicle user to communicate with the vehicle 12 and/or control various aspects or functions of the vehicle. Information from the mobile device 90a and/or the mobile device 90b may be pushed to the vehicle communication system 20. Such information includes, but is not limited to, various media such as music or videos, GPS navigation, calls, etc. In one embodiment, mobile device 90a is used by a first occupant of the vehicle 12 and the mobile device 90b is used by a second occupant of the vehicle 12.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. The vehicle 12 may include a vehicle communications system 20 as shown generally in FIG. 1. The vehicle communication system 20 may include one or more pairing sites 30a, 30b, a primary mobile device pairing locus 40, one or more vehicle system modules 42, and an infotainment system 50. Numerous other components and devices, including those not specifically illustrated, may be included as well. For example, vehicle communication system 20 may include a GPS module 60, one or more wireless adapters 62, and/or other vehicle system modules 42 which could include anything from engine or powertrain control modules to telematics units or any other operational vehicle module. Some or all of the different components may be connected for communication with each other via one or more communication buses, such as bus 44. Communications bus 44 provides various vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) such as the pairing sites 30a, 30b, primary mobile device pairing locus 40, infotainment system 50 including vehicle user interfaces 52-58, and GPS module 60. The vehicle 12 can also include other VSMs 42 in the form of electronic hardware components that are located throughout the vehicle. Each of the VSMs 42 is preferably connected by communications bus 44 to the other VSMs. One or more VSMs 42 may periodically or occasionally have their software or firmware updated and, in some embodiments, such vehicle updates may be over the air (OTA) updates that are received from a computer 78 or remote facility 80 via land network 76 and a telematics module or the like. As is appreciated by those skilled in the art, the above-mentioned VSMs are only examples of some of the modules that may be used in vehicle 12, as numerous others are also possible.

Infotainment system 50 may interact with a mobile device 90 and can provide various functionalities to one or more vehicle occupants. The infotainment system may include any system, module, device, etc. that provides visual, audio, tactile, etc. output to a vehicle occupant. Further, the infotainment system need not be its own stand-alone system, and may include parts or devices from a number of other vehicle subsystems. The infotainment system 50 may include a number of vehicle user interfaces that provide vehicle occupants with a means of providing and/or receiving information, including pushbutton(s) 52, audio system 54, microphone 56, and visual display 58. As used herein, the term “vehicle user interface” broadly includes any suitable form of electronic device, including both hardware and software components, which is located on the vehicle and enables a vehicle user to communicate with or through a component of the vehicle. The pushbutton(s) 52 allow manual user input to provide data, responses, or control inputs. Audio system 54 provides audio output to a vehicle occupant and can be a dedicated, stand-alone system or part of the primary vehicle audio system. According to the particular embodiment shown here, audio system 54 is operatively coupled to both vehicle bus 44 and an entertainment bus (not shown) and can provide AM, FM and satellite radio, CD, DVD and other multimedia functionality. Microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation. To cite one example, the infotainment system may not include a separate microphone 56, display 58, or GPS module 60, and instead, may interact with the mobile device 90 to provide the various inputs or outputs relating to these vehicle user interfaces.

Global position system (GPS) module 60 receives radio signals from a constellation of GPS satellites (not shown). From these signals, the module 60 can determine vehicle position which may enable the vehicle to determine whether it is at a known location, such as home or workplace. GPS module 60 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GPS module 60), or some or all navigation services can be done via a telematics unit installed in the vehicle, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 78, for other purposes, such as fleet management and/or for use in a car sharing service. Also, new or updated map data can be downloaded to the GPS module 60 from the remote facility 80 via a vehicle telematics unit.

The infotainment system 50 may provide vehicle occupants with information from a mobile device 90 via connection through a primary mobile device pairing locus 40 and/or a pairing site 30. The primary mobile device pairing locus 40 can include one or more antennas (not shown) and may be a SRWC device that is equipped with Bluetooth™ technology, to cite one example, although communication via any protocol is certainly possible. In some embodiments, the primary mobile device pairing locus 40 may include a processor, chipset, and/or multiple antennas. Pairing a mobile device 90 via the primary mobile device pairing locus 40 may be accomplished via voice commands received through microphone 56 and/or via menu-based commands received via push button 52 and/or screen 58 of the infotainment system 50. The primary mobile device pairing locus 40 may be incorporated or included as a part of one or more other vehicle system modules, such as a center stack module (CSM), body control module, an infotainment module, a telematics module, a head unit, and/or a gateway module. In one embodiment, the primary mobile device pairing locus 40 may be accessible to one or more mobile devices located anywhere within an interior 14 of vehicle 12. In another embodiment, the vehicle 12 may not have a primary mobile device pairing locus, and may pair with a mobile device 90 via a pairing site 30, which will be discussed in further detail below. The primary mobile device pairing locus 40 may be connected in any operable fashion to the pairing sites 30a, 30b and/or bus 44.

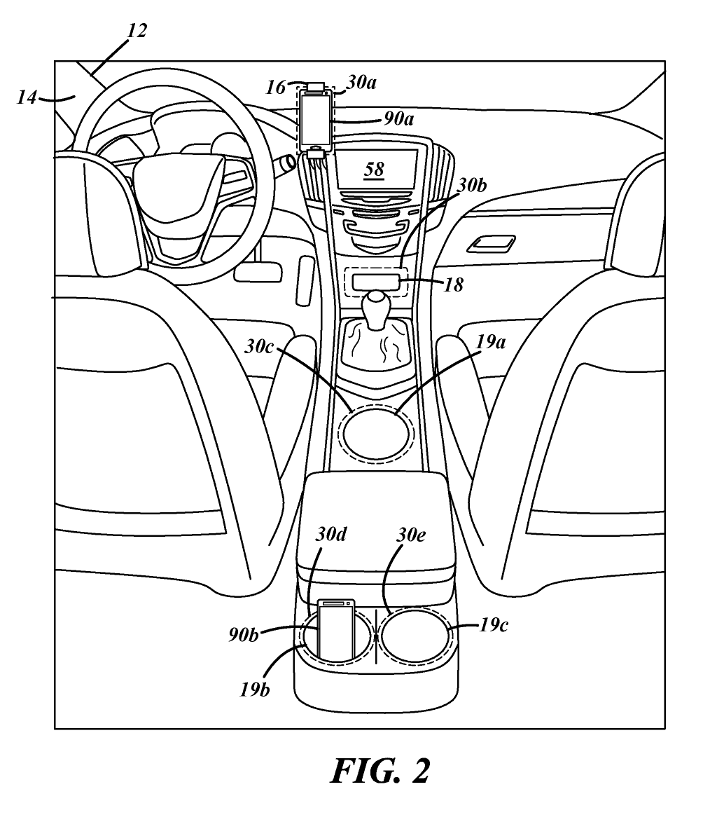

Pairing sites 30 are located at discrete locations of the interior 14 of the vehicle 12. The pairing site may be configured to override at least some functionality of a mobile device paired via the primary mobile device pairing locus. In the vehicle communications system 20 of FIG. 1, two pairing sites 30a and 30b are shown. Each pairing site 30 may include a proximity sensor 32, a processor 34, memory 36, and an antenna 38. It is also possible for the pairing site 30 to interact with a proximity sensor that is remote from the pairing site, such as through the use of one or more wireless access points 62. FIG. 2 illustrates another embodiment showing five different pairing sites 30a, 30b, 30c, 30d, and 30e. The vehicle 12 may include more or less pairing sites 30 than what is shown in the illustrated embodiments. Further, the pairing sites 30 may be located in different locations than what is illustrated in FIG. 2, as FIG. 2 is provided to show different examples of potential pairing site locations.

As shown in FIG. 2, the pairing site 30 may be located in any one of a variety of locations. According to one embodiment, it is desirable to have one or more pairing sites located in phone storage or charging locations that are easily accessible to one or more occupants. In the illustrated embodiment, there is a pairing site 30a located at a phone dock 16; a pairing site 30b located at a center console bin or tray 18; as well as pairing sites 30c, 30d, 30e which are located in cup holders 19a, 19b, 19c, respectively. Other pairing site locations are certainly possible, such as other console bins, charger pads, different cup holders, door storage areas, or any other feasible location.

The pairing sites 30 may be one of a variety of types of pairing sites including a total functionality pairing site, an all-media pairing site, a partial media pairing site, or a vehicle-based functionality pairing site. Depending on the type of pairing site, information may be selectively provided and/or taken from one or more particular vehicle modules and/or vehicle user interfaces. A total functionality pairing site would allow any or all possible information to be pushed from the mobile device 90 to the vehicle 12. For example, pairing site 30a which is associated with docking station 16 may be a total functionality pairing site. GPS directions from the mobile device 90a may be pushed and provided to the driver through the audio system 54, to cite one example. In another example, video-based media may be pushed from the mobile device 90a to the display 58. Other examples are certainly possible. An all-media pairing site may allow for music, videos, etc. to be pushed to the vehicle, while not providing for calls to be routed through the vehicle. For example, in FIG. 2, mobile device 90b may pair with the vehicle 12 when associated with pairing site 30d when placed in the cup holder 19b. It may be desirable for the pairing site 30d to be an all-media pairing site or a partial media pairing site (e.g., only music) in which a vehicle occupant seated in the back seat can play his or her music through the audio system 54. In a ride-sharing vehicle, for example, the vehicle occupant may not want calls routed through the vehicle, but could control the music being played. An all-media pairing site or a partial media pairing site in the back seat area of the vehicle which is accessible to one or more vehicle occupants in the rear of the vehicle could provide a more private pairing alternative. A partial media pairing site may be desirable in certain locations, such as near a display screen to selectively allow video or image-related information to be pushed from a mobile device. A vehicle-based functionality pairing site may selectively allow information relating to the operation of the vehicle to be pushed from the mobile device. This could include GPS information relating to the speed and/or position of the vehicle. In another embodiment, the mobile device could have an application program or the like which allows a user to establish certain preferred settings (seat position, HVAC temperature, or any other customizable vehicle setting). This information may be pushed to the vehicle when paired with the primary mobile device pairing locus, a total functionality pairing site, and/or a vehicle-based functionality pairing site. The types of pairing sites described herein (e.g., the total functionality pairing site, the all-media pairing site, the partial media pairing site, and the vehicle functionality pairing site) are meant to encompass all information types, combinations, etc. that can be provided to the vehicle via a mobile device. In some embodiments, it may be desirable to correlate the location of the pairing site with the type of pairing site. Some examples of this have already been provided, such as placing an all-media or partial media pairing site near the audio system 54 or near a display screen 58. Other examples are certainly possible.

Returning to FIG. 1, each pairing site 30 is illustrated as having a proximity sensor 32, a processor 34, memory 36, and an antenna 38. This is merely an example, however, and the pairing site may be configured differently than what is schematically illustrated in FIG. 1. In one example, the pairing site 30 is an integrated near-field communication (NFC) chipset which constitutes a proximity sensor since the mobile device must be relatively close to the NFC chipset in order to facilitate pairing. However, the pairing site 30 may be configured to communicate wirelessly according to any operable protocol, such as any of the IEEE 802.11 protocols, Wi-Fi™, WiMAX™, ZigBee™, Wi-Fi Direct™ Bluetooth™, or Bluetooth Low Energy™ (BLE).

In some embodiments, the paring site may include a dedicated proximity sensor, as indicated in FIG. 1, which detects the presences of the mobile device 90. Such sensors may include devices that detect the mobile device 90 directly by, for example, optical, capacitive, or magnetic sensors, or that detect an operating characteristic of the mobile device 90, such as by detecting a suitable signal strength being transmitted from the mobile device 90. In other embodiments, instead of the pairing site including its own dedicated, local proximity sensor 32, one or more wireless adapters 62 may be used as a proximity sensor to ascertain whether a mobile device is located at or near a pairing site 30. The wireless adapters 62 may be a wireless access point that determines the position of the mobile device 90 using a received signal strength indication (RSSI). In one embodiment, three or more wireless adapters 62 may be used with trilateration or multilateration techniques, respectively, to calculate the position of the mobile device relative to the wireless adapters. Depending on the design of the interior 14 of the vehicle 12, certain positions may be deemed a pairing site and may trigger pairing of a mobile device when it is determined by the wireless adapters 62 that the mobile device is at or within a certain distance from the pairing site.

The proximity sensor 32, 62 may be configured to determine a position of the mobile device 90 in the vehicle 12, and may use the position of the mobile device to trigger pairing when the mobile device is inside of a prescribed range as determined at least partly by the proximity sensor. The prescribed range may be a certain radius or distance from a feature of the vehicle (e.g., console bin, cup holder, etc.) and may vary depending on the size of the feature. For example, the prescribed range may be 0 to 6 inches from a feature of the vehicle. Other ranges are certainly possible. In one embodiment, when the mobile device is inside of a prescribed range as determined at least partly by the proximity sensor, information will be pushed from the mobile device to the vehicle. The manner in which information is pushed from the mobile device may be controlled via one or more customizable rules associated with the pairing site. For example, if the pairing site is not a total functionality pairing site, only certain types of information may be pushed to the vehicle when the mobile device is inside of the prescribed range as determined proximity sensor. Moreover, the proximity sensor may allow for increased pairing flexibility when a mobile device moves from inside of the prescribed range to outside of the prescribed range. For example, if an occupant receives a phone call that is being pushed or transmitted through the audio system of the vehicle when the mobile device is at an associated pairing site, the occupant may be able to remove the mobile device from the pairing site to stop pairing and enter a private mode on the call. Placing the mobile device back at the pairing site may trigger pairing and resume pushing or transmitting the call through the audio system of the vehicle.

The processor 34 and memory 36 of the pairing site 30 may be a distinct electronic processor and memory dedicated solely to the pairing site, or they may be associated and/or interact with a number of other vehicle subsystems or other pairing sites. Processor 34 can be any type of device capable of processing electronic instructions including microprocessors, microcontrollers, host processors, controllers, vehicle communication processors, and application specific integrated circuits (ASICs). Processor 34 executes various types of digitally-stored instructions, such as software or firmware programs stored in memory 36, which can enable the customizable nature of pairing site 30. Memory 36 may include RAM, other temporary powered memory, any non-transitory computer-readable medium (e.g., EEPROM), or any other electronic computer medium that stores some or all of the software needed to carry out the various device functions discussed herein.

Pairing may be carried out using a known protocol supported by the particular wireless technology used; for example, according to an NFC or Bluetooth™ standard process. Pairing at a pairing site 30 may be automatic, meaning that no password (e.g., secret key, identifier, or the like) is needed to establish a connection. Pairing at certain pairing sites 30 may not be automatic, such that if a new mobile device is inside of the pairing site, a prompt for a password may be required. Additionally, a pairing site 30 may be configured such that if a mobile device has previously been paired with the primary mobile device pairing locus or another pairing site, the password would not be required. One or more pairing sites may have customizable rules to address security preferences for pairing. Additionally, various functionalities may be preferred or weighted depending on which pairing site is being paired with a mobile device. For example, pairing via the pairing site 30a at the phone dock 16 shown in FIG. 2 may allow for certain functionalities and may override pairing functionality if mobile device 90b is paired via the pairing site 30d at the cup holder 19b. More particularly, if pairing site 30a is a total functionality pairing site, but the mobile device 90a is not playing music through the vehicle user interfaces, the mobile device 90b may play music through the vehicle user interfaces (e.g., if pairing site 30d is an all-media or partial media pairing site). If a vehicle occupant in the front of the vehicle decides to play music through mobile device 90a, however, such a request may override the pairing via pairing site 30d. Similar examples are certainly feasible.

In some embodiments, a graphical user interface (GUI) may be used to customize the pairing site rules. The GUI may be provided via any operable platform, such as via touchscreen 58 or an application program on mobile device 90. The GUI may give the vehicle occupant options for choosing pairing site locations and/or changing the rules at a particular pairing site once a pairing site is established. The GUI may have an option to automate or standardize the pairing site layout and functionality such that the user does not have to change or customize the rules. Other options are possible.

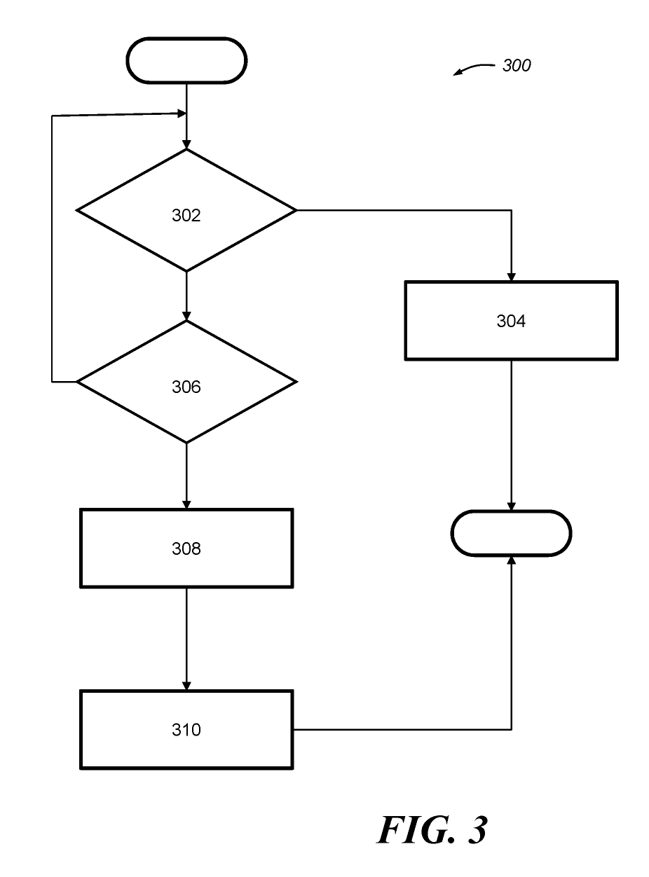

With reference to FIG. 3, there is shown an embodiment of a method 300 that may be used with one or more of the system embodiments described above. While the method 300 is described with relation to the vehicle communications system 20 depicted in FIGS. 1 and 2, any other operable system may be used to carry out one or more of the method steps. Further, the method described herein is merely one example of different steps or queries that may be used in conjunction with any of the disclosed systems and their equivalents.

Step 302 asks whether a mobile device is paired via the primary mobile device pairing locus 40. This step may be carried out in a number of ways, such as via typical menu-based or vocal-based pairing methods which allow an occupant of the vehicle to pair a mobile device irrespective of the device's location within the interior of the vehicle. The method then continues to step 304 if a mobile device is paired via the primary mobile device pairing locus, or instead continues to step 306 if a mobile device is not paired via the primary mobile device pairing locus.

In step 304, information is pushed from the mobile device paired via the primary mobile device pairing locus depending on the occupation of one or more pairing sites 30. Since the pairing sites 30 allow for custom rules and preferences, such rules and preferences will be reconciled with the pairing via the primary mobile device pairing locus to provide the vehicle occupant(s) customizable pairing experiences. Determining the occupancy of the pairing sites 30 and the associated rules and preferences may be accomplished via steps 306-310 of the method.

Step 306 asks whether a mobile device is paired via a pairing site 30. In step 306, one mobile device may be detected, such as mobile device 90a associated with pairing site 30a. More than one mobile device may be detected, such as mobile device 90a and mobile device 90b associated with pairing site 30d. To detect a mobile device, a proximity sensor 32, 62 may be used. The proximity sensor 32, 62 may detect whether a mobile device is within a prescribed radius of the pairing site 30. If there is no mobile device paired via a pairing site 30 or via the primary mobile device pairing locus, the method may return to the beginning until a mobile device is paired. If one or more mobile devices are paired via a pairing site, then the method may continue to step 308.

In step 308, the method determines which custom rule(s) apply to the paired pairing site(s) of step 306. The custom rules can take a variety of forms depending on the desired implementation. For example, the discrete location of the pairing site may correlate with the type of pairing site. In one example, a pairing site near a display screen 58 may be an all-media or partial media pairing site. The custom rules may weigh or may establish preferences for information from one mobile device or another depending on the location of the pairing site. Other example rules are certainly possible.

Step 310 of the method involves pushing information from one or more paired mobile devices to the vehicle in accordance with the custom rule(s). Information may be transmitted to the vehicle occupant(s) via the vehicle user interfaces, such as audio system 54, microphone 56, and/or visual display 58. As described above, there are many possible implementations for how and when information is transmitted, and accordingly, step 310 may be carried out in accordance with any of these different implementations.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

1. A communications system for a vehicle, comprising:
a primary mobile device pairing locus, wherein the primary mobile device pairing locus is configured to be accessible to a mobile device in the vehicle from any location within an interior of the vehicle; and
a pairing site, wherein the pairing site is located at a discrete location within the interior of the vehicle and is configured to be one of the following types of pairing sites: a total functionality pairing site, an all-media pairing site, a partial media pairing site, or a vehicle-based functionality pairing site,
wherein the pairing site is configured to override at least some functionality of a mobile device paired via the primary mobile device pairing locus when a mobile device is paired via the pairing site.

2. The communications system of claim 1, further comprising a second pairing site, wherein the second pairing site is located at a second discrete location within the interior of the vehicle and is configured to be one of the following types of pairing sites: a total functionality pairing site, an all-media pairing site, a partial media pairing site, or a vehicle-based functionality pairing site.

3. The communications system of claim 2, wherein the first pairing site and the second pairing site are different types of pairing sites.

4. The communications system of claim 1, wherein the discrete location of the pairing site includes a phone docking station, a console bin, or a cup holder.

5. The communications system of claim 1, wherein the pairing site includes a proximity sensor configured to determine a position of a mobile device in the vehicle.

6. The communications system of claim 5, wherein the proximity sensor is configured such that when the mobile device is inside of a prescribed range as determined at least partly by the proximity sensor, information will be pushed from the mobile device to a vehicle user interface.

7. The communications system of claim 5, wherein the proximity sensor is configured such that when the mobile device is outside of a prescribed range as determined at least partly by the proximity sensor, information will not be pushed from the mobile device to a vehicle user interface.

8. The communications system of claim 1, wherein the discrete location includes a mobile device charger.

9. The communications system of claim 1, wherein the type of pairing site is an all-media pairing site or a partial media pairing site, and the discrete location is in a back seat area of the vehicle.

10. The communications system of claim 1, wherein the pairing site is an all-media pairing site or a partial media pairing site associated with a display screen.

11. A communications system for a vehicle, comprising:
an infotainment system including a vehicle user interface; and
a pairing site that is located at a discrete location within the interior of the vehicle and is configured to be one of the following types of pairing sites: a total functionality pairing site, an all-media pairing site, a partial media pairing site, or a vehicle-based functionality pairing site,
wherein the pairing site includes a proximity sensor configured to determine a position of a mobile device in the vehicle, and when the mobile device is moved from inside of a prescribed range as determined at least partly by the proximity sensor to outside of the prescribed range as determined at least partly by the proximity sensor, information will stop being pushed from the mobile device to the vehicle user interface of the infotainment system such that pairing functionality of the mobile device is dependent on the position of the mobile device in the vehicle.

12. The communications system of claim 11, wherein the proximity sensor is a wireless access point that is configured to determine a position of a mobile device using a received signal strength indication (RSSI).

13. The communications system of claim 11, wherein a communication protocol of the pairing site is near field communication (NFC), Bluetooth, or Bluetooth Low Energy (BLE).

14. The communications system of claim 11, wherein the information being pushed from the mobile device is a cellular call that is placed into a private mode when the mobile device is moved from inside of the prescribed range to outside of the prescribed range.

15. A communications system for a vehicle, comprising:
a first pairing site for a mobile device, the first pairing site being one of the following types of pairing sites: a total functionality pairing site or a vehicle-based functionality pairing site; and
a second pairing site for a mobile device, the second pairing site being one of the following types of pairing sites: an all-media pairing site or a partial media pairing site,
wherein the first pairing site and the second pairing site are located in different discrete locations within an interior of the vehicle, with the first pairing site being located at a phone docking station or a console bin and the second pairing site being located in a back seat area of the vehicle.

16. The communications system of claim 15, wherein pairing is automatic at the first pairing site and pairing at the second pairing site requires a password.

17. (canceled)
